(19) United States
(12) Patent Application Publication
(10) Pub. No.: US 2003/0231570 A1
(43) Pub. Date: Dec. 18, 2003

(54) Recording and reproducing device

(75) Inventor: Kengo Oishi, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/461,357

(22) Filed: Jun. 16, 2003

(30) Foreign Application Priority Data
Jun. 14, 2002 (JP) 173852/2002
Jul. 22, 2002 (JP) 212584/2002

(51) Int. Cl. G11B 33/02; G11B 23/00; G11B 25/00

(52) U.S. Cl. 369/75.1; 369/263

(57) ABSTRACT

A recording and reproducing device has a recording/reproducing unit which records electronic information on a recording medium and reproduces electronic information from a recording medium by the use of a recording/reproducing head which is moved relatively to the recording medium, an information input unit which inputs electronic information to be recorded on the recording medium and a control unit which controls the recording/reproducing unit and the information input unit. The units are separately integrated and are provided with casings which are substantially of the same shape in plan. A holder means releasably holds the units together with the substantially same shapes of the casings of the respective units superposed one on another. A vibration damper which absorbs at least vibration in the direction in which the recording/reproducing head is moved is disposed between the part of the recording/reproducing unit holding the recording/reproducing head and the casing of the same.

### BACKGROUND OF THE INVENTION

1. Field of the Invention

This invention relates to a recording reproducing device for recording and reproducing electronic information such as image data, and more particularly, to a recording and reproducing device in which the part for recording and reproducing the electronic information and the part for inputting the electronic information are separately unitized.

2. Description of the Related Art

There have been known a so-called digital camera which stores still images of objects in a recording medium such as a memory or a magnetic disc in the form of electronic information and a video camera which stores animations in a recording medium such as a magnetic tape or a magnetic disc in the form of electronic information. Further, as a device for recording various kinds of data in a recording medium in the form of electronic information, there have been provided a personal computer, a PDA (Personal Data Assistants) and the like.

In devices where electronic information is recorded and reproduced by the use of a recording medium, functional parts such as the part for recording and reproducing the electronic information (will be referred to as the “recording/reproducing part”, hereinbelow) and the part for inputting the electronic information into the recording/reproducing part (will be referred to as the “information input part”, hereinbelow and, for instance, an image taking system in a video camera) are generally unitized including a display part which displays the contents of record such as the still images and animations including the result of operation. Whereas, for instance, a large capacity battery which is additionally used in a video camera or a magnetic disc drive which is additionally used in a PDA is sometimes formed separately from the body portion of the recording and reproducing device to be connected to the body portion as desired so that the recording and reproducing device is expandable.

However, in a recording and reproducing device where the functional parts are all unitized, it is practically impossible to meet a demand of so-called upgrade, for instance, to change only the recording/reproducing part comprising, for instance, a magnetic disc drive, and in order to upgrade the recording and reproducing device, the entire recording and reproducing device must be substituted by a new expensive one. Further, in such a recording and reproducing device, for instance, when only the recording/reproducing part fails beyond repair, the entire recording and reproducing system must be repurchased irrespective that the other parts are normal, which is waste of resources and forces heavy economical load to the consumers.

In a recording and reproducing device comprising a body portion and an additional functional parts formed separately from the body portion, the situation is all the same as for the functional parts forming the body portion of the device though the additional functional part can be easily changed.

Further, in the case of a recording and reproducing device comprising a body portion and an additional functional parts formed separately from the body portion, there has been a problem that, for instance, the additional large capacity battery greatly projects outside the body portion thereof or the additional magnetic disc drive is unstably connected to the body portion only through a wire, which inconveniences the user.

In the case of a recording and reproducing device provided with a recording/reproducing head which is moved relatively to the recording medium, the head can be shifted from the correct home position if the device is dropped and a shock is imparted in the head scanning direction (the direction in which the head is moved). When the head is shifted from the correct home position, the head can run a path deviated from the correct path and can record an incorrect record. Though it is possible to return the head to the correct path by so-called tracking servo in the recording/reproducing unit using an optical disc or a magnetic disc, it is difficult to correct information when the head is in a wrong home position and the information has been recorded in a wrong position on the recording medium.

### SUMMARY OF THE INVENTION

In view of the foregoing observations and description, the primary object of the present invention is to provide a recording and reproducing system which does not waste the usable parts upon change of a functional part and is nevertheless expandable.

Another object of the present invention is to provide a recording and reproducing device with a recording/reproducing head which is moved relatively to the recording medium, which device does not waste the usable parts upon change of a functional part, is nevertheless expandable and at the same time can prevent the head from being shifted from the correct home position even if the device is dropped and a shock is imparted in the head scanning direction.

In accordance with a first aspect of the present invention, there is provided a recording and reproducing device comprising a recording/reproducing unit which records electronic information on a recording medium and reproduces electronic information from a recording medium, an information input unit (e.g., a digital camera, a video camera or a PDA) which inputs electronic information to be recorded on the recording medium and a control unit which controls the recording/reproducing unit and the information input unit, wherein the improvement comprises that

the units are separately integrated and are provided with casings which are substantially of the same shape in plan, and

a holder means releasably holds the units together with the substantially same shapes of the casings of the respective units superposed one on another.

In accordance with a second aspect of the present invention, there is provided a recording and reproducing device comprising a recording/reproducing unit which records electronic information on a recording medium and reproduces electronic information from a recording medium by the use of a recording/reproducing head which is moved relatively to the recording medium, an information input unit (e.g., a digital camera, a video camera or a PDA) which inputs electronic information to be recorded on the recording medium and a control unit which controls the recording/reproducing unit and the information input unit, wherein the improvement comprises that

the units are separately integrated and are provided with casings which are substantially of the same shape in plan,

a holder means releasably holds the units together with the substantially same shapes of the casings of the respective units superposed one on another, and

a vibration damper which absorbs at least vibration in the direction in which the recording/reproducing head is moved is disposed between the part of the recording/reproducing unit holding the recording/reproducing head and the casing of the same.

In the device of the present invention, another unit or other units such as a display unit which may comprise, for instance, a liquid crystal panel, a GPS (Global Positioning System) unit for detecting the position on the earth, a radio data communication unit (e.g., a LAN card) or an IF (interface) unit which wirelessly connects an IC card with an external device may be added to the recording/reproducing unit, the information input means and the control unit or may be changed for one or more of the recording/reproducing unit, the information input means and the control unit.

As the recording/reproducing unit having such a recording/reproducing head, those employing a magnetic disc, an optical disc, a magneto-optical disc or the like as the recording medium can be suitably employed.

As the vibration damper, a vibration damper alloy comprising 73% of Mn, 20% of Cu, 5% ofNi and 2% of Fe, synthetic resin or rubber may be employed. It is preferred that the vibration damper be continuously or stepwise varied in its thickness so that vibrations of different natural frequencies can be absorbed. Needless to say the vibration damper may absorb vibrations in various directions in addition to the vibration in the head scanning direction (the direction in which the recording/reproducing head is moved).

In the recording and reproducing device of the present invention, since the units are separately housed in casings and are held together by the holder means, one or more of the units may be changed for upgrade or repair without discarding the other units. Accordingly, it becomes unnecessary to waste the other parts of the recording and reproducing device which can be still used, which results in effective use of the resources and lightening economical load to the consumers.

Further, since the holder means holds the units together with the substantially same shapes of the casings of the respective units superposed one on another, the units can be stably integrated and the recording and reproducing device can be conveniently handled.

Even if a quite novel information input unit comes to be provided in the future, the novel information input unit can be added to the recording and reproducing device, and accordingly, the recording and reproducing device of the present invention is highly expandable and can be usable for long.

In the recording and reproducing device of the second aspect of the present invention, a recording/reproducing unit provided with a recording/reproducing head which is moved relatively to the recording medium is employed. In such a recording/reproducing unit, the head can be shifted from the correct home position if the unit is dropped and a shock is imparted in the head scanning direction. When the head is shifted from the correct home position, the head can run a path deviated from the correct path and can record an incorrect record. Though it is possible to return the head to the correct path by so-called tracking servo in the recording/reproducing unit using an optical disc or a magnetic disc, it is difficult to correct information when the head is in a wrong home position and the information has been recorded in a wrong position on the recording medium.

Whereas, in the case of the recording and reproducing device of the second aspect of this invention, the vibration damper disposed between the part of the recording/reproducing unit holding the recording/reproducing head and the casing of the same effectively prevents the head from being shifted from its correct home position in the head scanning direction.

### BRIEF DESCRIPTION OF THE DRAWINGS

FIG. 1 is a perspective view showing a recording and reproducing device in accordance with a first embodiment of the present invention with the display unit closed,

FIG. 2 is a perspective view showing the recording and reproducing device in accordance with the first embodiment of the present invention with the display unit opened,

FIG. 3 is a fragmentary front view for illustrating a recording and reproducing device in accordance with a second embodiment of the present invention, and

FIG. 4 is a perspective view showing a recording and reproducing device in accordance with a third embodiment of the present invention.

### DESCRIPTION OF THE PREFERRED EMBODIMENTS

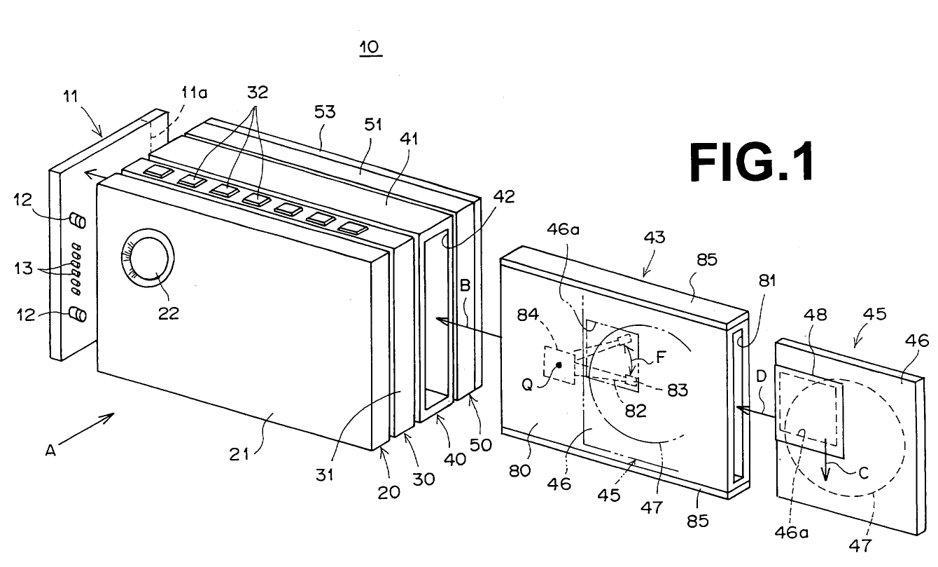

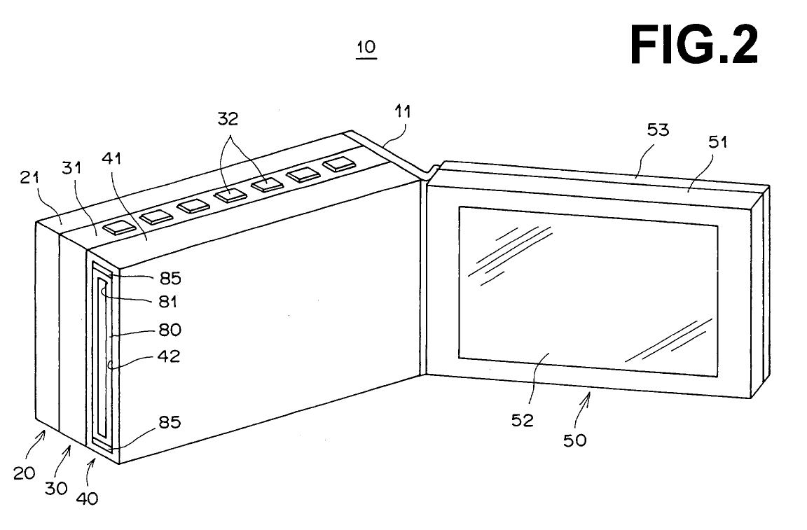

In FIGS. 1 and 2, a recording and reproducing device 10 in accordance with a first embodiment of the present invention is a digital camera for taking still pictures, and comprises a camera unit (an information input unit) 20, a control unit 30, a recording/reproducing unit 40, a display unit 50 and a joint 11 which holds together the units 20, 30, 40 and 50. Each of the units 20, 30, 40 and 50 has a casing 21, 31, 41 or 51 which is shaped and sized like a PCMCIA® type-II PC card in plan (as seen in the direction of arrow A in FIG. 1) and in which elements for performing the respective functions are housed.

The camera unit 20 is provided with a taking lens 22 and is basically of the same structure as a known digital camera. The camera unit 20 is fixedly connected to the joint 11 by inserting a pair of connecting pins 12 on the joint 11 into respective holes (not shown) on a side face thereof and released from the joint 11 by drawing the connecting pins 12 from the holes or by operating a releasing member (not shown).

The control unit 30 has therein a battery for driving the units 20, 40 and 50, and is provided with a plurality of control buttons 32 for controlling the units 20, 40 and 50. The control unit 50 is connected to the joint 11 in the same manner as the camera unit 20.

The recording/reproducing unit 40 is, for instance, for releasably holding a drive unit 43 which drives a magnetic disc cartridge 45. That is, the drive unit 43 is integrally held by a casing 41 of the recording/reproducing unit 40 when inserted into the casing 41 in the direction of arrow B through a drive port 42 formed in the casing 41. In this state, the drive unit 43 is electrically connected to an electric circuit (not shown) in the casing 41 through a connector (not shown). When an eject button (not shown) is pushed in this state, the drive unit 43 is ejected outside the casing 41. The recording/reproducing unit 40 is connected to the joint 11 in the same manner as the camera unit 20.

The magnetic disc cartridge 45 comprises a thin housing 46 formed by bonding upper and lower shell halves and a 1.8 inch flexible magnetic disc 47 housed for rotation in the housing 46. The housing 46 is provided with a head insertion window 46a through which a magnetic head of the recording/reproducing unit 40 accesses the magnetic disc 47. The magnetic disc cartridge 45 is provided with a shutter which is movable between an opening position where it opens the opening and a closing position where it closes the opening. The cartridge 45 is loaded in the drive unit 43 by inserting into the drive unit 43 through a cartridge port 81 formed in the casing 80 of the drive unit 43 in the direction of arrow D. When the rear end of the magnetic disc cartridge 45 is further pushed slightly in this state, the magnetic disc cartridge 45 is ejected outside the drive unit 43.

While the cartridge 45 is not in use, the head insertion window 46a is closed by the shutter 48. When the cartridge 45 is inserted into the cartridge port 81 in the direction of arrow D, the shutter 48 is moved to the opening position in the direction of arrow C by a shutter opening member of the drive unit 43 to open the head insertion window 46a.

The drive unit 43 is provided in the casing 80 with a magnetic head arm 82, a recording/reproducing magnetic head 83 mounted on the tip of the arm 82, and a base 84 which fixedly supports the arm 82 and is rotated on a pivot Q. When the base 84 is rotated on the pivot Q, the magnetic head arm 82 is rotated as shown by a double-headed arrow F in FIG. 1. Vibration-dampers 85 in the form of plates of vibration damper alloy are mounted on the upper and lower end faces of the casing 80. When the drive unit 43 is in the casing 41 of the recording/reproducing unit 40, the vibration dampers are interposed between the casing 80 supporting the magnetic head 83 and the casing 41 of the recording/reproducing unit 40.

The display unit 50 may comprise, for instance, a liquid crystal panel and is connected to the joint 11 in the same manner as the camera unit 20. The display unit 50 is connected to the joint 11 with its screen 52 facing the recording/reproducing unit 40. On the rear face of the display unit 50 (the face opposite to the screen 52), an additional large capacity battery 53 is mounted.

The joint 11 is formed of, for instance, synthetic resin to hold a plurality of (e.g., four) units and the part holding the display unit 50 is connected to the part holding the other units 20, 30 and 40 by way of a hinge 11a extending in the direction of height of the display unit 50 so that the display unit 50 is closed as shown in FIG. 1 and opened as shown in FIG. 2.

The joint 11 not only mechanically connects the units 20, 30, 40 and 50 but also electrically connects the units 20, 30, 40 and 50 by way of connector pins 13 (only those for camera units 20 appear in FIG. 1) and printed circuits formed inside the respective units.

Operation of the recording and reproducing device 10 of this embodiment will be described, hereinbelow. When using the recording and reproducing device 10, a magnetic disc cartridge 45 is loaded in the drive unit 43, and the drive unit 43 is inserted into the casing 41 of the recording/reproducing unit 40. Then by depressing one of the control buttons 32 of the control unit 30 with the taking lens 22 of the camera unit 20 directed toward an object, the camera unit 20 is electrically actuated to take a picture of the object.

The control buttons 32 include one for releasing the shutter of the camera unit 20 and, in the case where the camera unit 20 has an optical or electrical zooming function, one for zooming. When another information input unit, e.g., an aforesaid PDA unit is to be connected in place of the camera unit 20, additional control buttons 32 for controlling the another information input unit may be provided separately from the control buttons 32 for controlling the camera unit 20. Otherwise, each control button 32 may be provided in common to different units with a display for describing the control button changed with change of the units. In this case, it is preferred that the respective information input units be arranged to output different symbol signals and the control unit 30 identifies the symbol signal output from the information input unit connected thereto by way of the joint 11 so that the display for describing the control button is automatically changed according to the information input unit connected to the control unit 30 by way of the joint 11.

The camera unit 20 inputs image data representing the picture taken into the recording/reproducing unit 40, and the recording/reproducing unit 40 causes the drive unit 43 to record the image data on the disc cartridge 45. A picture of an object may be taken viewing the screen 52 of the display unit 50 as a viewfinder. When the image recording and reproducing device 10 is not used, the display unit 50 is closed as shown in FIG. 1 to protect the screen 52 from being damaged or contaminated.

It is possible to reproduce a still image represented by the image data recorded on the magnetic disc cartridge 45 on the screen 52 of the display unit 50 by the drive unit 43 of the recording/reproducing unit 40. At this time, the recording/reproducing unit 40 is controlled through the control buttons 32 of the control unit 30.

The image data is recorded and reproduced by the magnetic head 83 of the drive unit 43. That is, the magnetic head 83 is brought close to the magnetic disc 47 of the cartridge 45, which is being rotated in the housing 46, through the head insertion window 46a and image data is recorded on or read out from the magnetic disc 47 by the magnetic head 83.

When the magnetic head arm 82 is rotated as shown by the double-headed arrow F in FIG. 1, the magnetic head 83 is moved between the innermost recording track to the outermost recording track of the magnetic disc 47. When the magnetic head arm 82 is in the lower position of the two positions shown by the broken line in FIG. 1, the magnetic head 83 is given access to the innermost track and when the magnetic head arm 82 is in the upper position of the two positions shown by the broken line in FIG. 1, the magnetic head 83 is given access to the outermost track.

As can be understood from the description above, in the recording and reproducing device 10 of this embodiment, since the camera unit 20, the control unit 30, the recording/reproducing unit 40 and the display unit 50 are separately housed in the casings 21, 31, 41 and 51 and are releasably held together by the joint 11, one or more of the units may be changed for upgrade or repair without discarding the other units. Accordingly, it becomes unnecessary to waste the other parts of the recording and reproducing device 10 which can be still used, which results in effective use of the resources and lightening economical load to the consumers.

Further, since the joint 11 holds the units 20, 30, 40 and 50 together with the substantially same shapes of their casings 21, 31, 41 and 51 superposed one on another, the units can be stably integrated and the recording and reproducing device can be conveniently handled.

Even if a quite novel information input unit comes to be provided in the future, the novel information input unit can be added to the recording and reproducing device, and accordingly, the recording and reproducing device 10 is highly expandable and can be usable for long.

In the recording/reproducing unit 40 of the recording and reproducing device 10 of this embodiment, the magnetic head 83 can be shifted from the correct home position if (for instance, the unit 40 is dropped) a shock is imparted in the head scanning direction (the directions indicated by the double-headed arrow F). When the head 83 is shifted from the correct home position, the head can run a path deviated from the correct path and can record an incorrect record. Since the recording and reproducing device of this embodiment is a digital camera, a shock can be imparted in the head scanning direction also by movement of hands or by vibrations imparted to the recording and reproducing device 10 when pictures are taken while the photographer is running.

However, in the case of the recording and reproducing device of this embodiment, since the vibration dampers 85 are disposed between the casing 41 of the recording/reproducing unit 40 which directly undergoes the shock and the casing 80 holding the recording/reproducing head 83 to be substantially opposed to the head scanning direction, a shock imparted in the head scanning direction can be absorbed by the dampers 85, whereby the head is effectively prevented from being shifted from its correct home position in the head scanning direction.

Further, since a large capacity battery 53 is mounted on the rear face of the display unit 50, the recording and reproducing device of this embodiment can be operated continuously for long by supplying power to the units 20, 30, 40 and 50 from the battery 53.

Though the recording and reproducing device 10 of this embodiment comprises four units 20, 30, 40 and 50, the recording and reproducing device 10 of this invention may comprise any number of units so long as the recording/reproducing unit, the information input unit and the control unit are included. For example, the display unit 50 may be eliminated to form a less expensive digital camera. Further, the holder means (joint 11) may be either originally formed to hold a particular number of (e.g., three or four) units or formed to hold an increased number of units by adding one or more unit holding portions.

The recording/reproducing unit need not be limited to those employing a magnetic disc cartridge as the recording medium but may be those employing a semiconductor memory or magnetic tape as the recording medium.

The information input unit need not be limited to the camera unit 20 but may be, for instance, a video camera unit, a GPS unit, a radio data communication unit or an IF unit which wirelessly connects an IC card with an external device. When provided with a plurality of information input units, a multi-function recording and reproducing device can be realized.

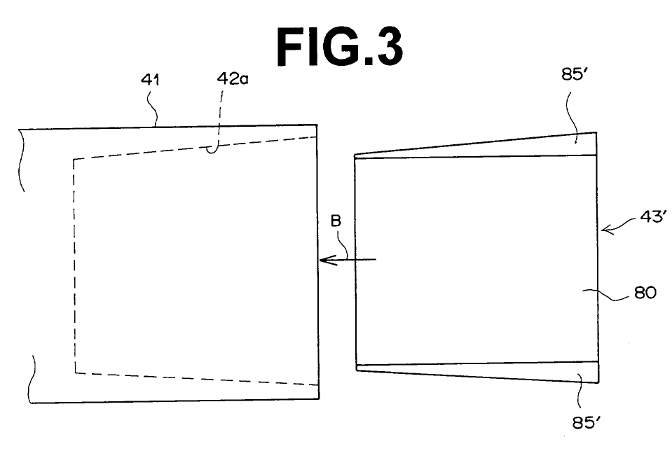

As shown in FIG. 3, the drive unit 43′ may be provided with wedge-shaped dampers 43′ on the upper and lower end faces thereof. The wedge-shaped damper 43′ continuously varies in its thickness and vibrations of different natural frequencies can be absorbed. When drive port 42a of the casing 41 for receiving the drive unit 43′ is tapered, the drive unit 43′ can be brought into engagement with the casing 41 light and surely held thereby.

Though, in the embodiment described above, the magnetic head 83 is moved along an arcuate path in response to rotation of the magnetic head arm 82, the magnetic head 83 may be moved along a straight path. In this case, by directing a damper in a direction in which the damper absorbs vibration in the direction of movement of the head 83, the same result as the first embodiment can be obtained.

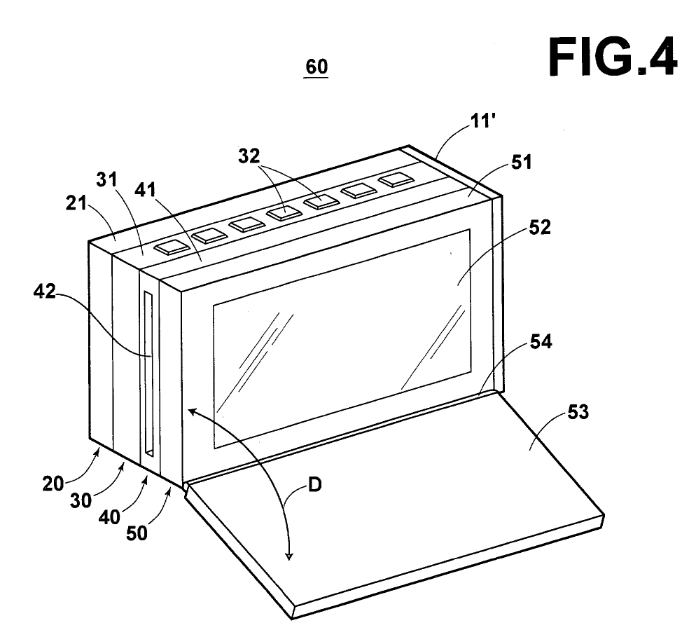

A recording and reproducing device in accordance with a third embodiment of the present invention will be described with reference to FIG. 4, hereinbelow. The recording and reproducing device in accordance with the third embodiment of the present invention is basically the same as that of the first embodiment. Accordingly, in FIG. 4, the elements analogous to those shown in FIG. 1 are given the same reference numerals and will not be described here.

The recording and reproducing device of this embodiment differs from that of the first embodiment in that the display unit 50 is connected to a joint 11′ with its screen 52 facing outward (positioned on the side remote from the recording/reproducing unit 40) and the additional large capacity battery 53 is mounted on the display unit 50 to cover the screen 52. Unlike the joint 11, the joint 11′ is not provided with the hinge 11a. Instead, the additional large capacity battery 53 is hinged to the display unit 50 by a hinge 54 to be opened and closed in the direction of double-headed arrow D. When the additional large capacity battery 53 is opened, the screen 52 is exposed, and when the additional large capacity battery 53 is closed, the screen 52 is covered.

What is claimed is:

1. A recording and reproducing device comprising a recording/reproducing unit which records electronic information on a recording medium and reproduces electronic information from a recording medium, an information input unit which inputs electronic information to be recorded on the recording medium and a control unit which controls the recording/reproducing unit and the information input unit, wherein the improvement comprises that
the units are separately integrated and are provided with casings which are substantially of the same shape in plan, and
a holder means releasably holds the units together with the substantially same shapes of the casings of the respective units superposed one on another.

2. A recording and reproducing device as defined in claim 1 in which the information input unit comprises at least one of a camera unit, a display unit, a GPS unit, a radio data communication unit and an IF unit which wirelessly connects an IC card with an external device.

3. A recording and reproducing device as defined in claim 1 in which the recording/reproducing unit employs a magnetic disc, an optical disc or a magneto-optical disc.

4. A recording and reproducing device comprising a recording/reproducing unit which records electronic information on a recording medium and reproduces electronic information from a recording medium by the use of a recording/reproducing head which is moved relatively to the recording medium, an information input unit which inputs electronic information to be recorded on the recording medium and a control unit which controls the recording/reproducing unit and the information input unit, wherein the improvement comprises that
the units are separately integrated and are provided with casings which are substantially of the same shape in plan,
a holder means releasably holds the units together with the substantially same shapes of the casings of the respective units superposed one on another, and
a vibration damper which absorbs at least vibration in the direction in which the recording/reproducing head is moved is disposed between the part of the recording/reproducing unit holding the recording/reproducing head and the casing of the same.

5. A recording and reproducing device as defined in claim 4 in which the information input unit comprises at least one of a camera unit, a display unit, a GPS unit, a radio data communication unit and an IF unit which wirelessly connects an IC card with an external device.

6. A recording and reproducing device as defined in claim 4 in which the recording/reproducing unit employs a magnetic disc, an optical disc or a magneto-optical disc.

7. A recording and reproducing device as defined in claim 4 in which the vibration damper is formed of a vibration damper alloy, synthetic resin or rubber.

8. A recording and reproducing device as defined in claim 7 in which the vibration damper is formed of a vibration damper alloy comprising 73% of Mn, 20% of Cu, 5% of Ni and 2% of Fe.

9. A recording and reproducing device as defined in claim 4 in which the vibration damper is continuously or stepwise varied in its thickness.
